(19) United States
(12) Patent Application Publication
(10) Pub. No.: US 2017/0322359 A1
(43) Pub. Date: Nov. 9, 2017

(54) DISPLAY DEVICE

(71) Applicant: Samsung Display Co., Ltd., Yongin-si (KR)

(72) Inventors: Seki PARK, Hwaseong-si (KR); Sung-kyu SHIM, Seoul (KR)

(21) Appl. No.: 15/583,168

(22) Filed: May 1, 2017

(30) Foreign Application Priority Data
May 4, 2016 (KR) 10-2016-0055596
Feb. 17, 2017 (KR) 10-2017-0021722

(51) Int. Cl. F21V 8/00; G02F 1/1368; G02F 1/1335; G02F 1/1339; G02F 1/1333

(52) U.S. Cl. CPC G02B 6/005; G02F 1/1339; G02F 1/1368; G02F 1/133514; G02F 1/133528; G02F 1/133526; G02F 2001/133302

(57) ABSTRACT

A display device includes a display member which displays an image and a light source which provides light to the display member. The display member includes a base substrate including a front surface, a rear surface, and a plurality of side surfaces which connects the front surface to the rear surface, where the base substrate receives the light through a side surface of the side surfaces and has a first refractive index, a low refractive layer disposed on the front surface and having a second refractive index less than the first refractive index, and an array layer disposed on the low refractive layer and including at least one thin film transistor. The low refractive layer has a predetermined thickness, which is greater than a penetration depth of the light in the low refractive layer.

This application claims priority to Korean Patent Application No. 10-2016-0055596, filed on May 4, 2016, and Korean Patent Application No. 10-2017-0021722, filed on Feb. 17, 2017, and all the benefits accruing therefrom under 35 U.S.C. §119, the contents of which in their entirety are herein incorporated by reference.

### BACKGROUND

### 1. Field

The disclosure herein relates to a display device, and more particularly, to a slim type display device.

### 2. Description of the Related Art

A slim type display device with low power consumption and high portability has been in the spotlight as next-generation high-tech display devices. Such a display device may include a thin film transistor for each pixel to control a turn on/off voltage applied to each pixel.

The display device may include a display panel and a backlight unit that provides light to the display panel. The backlight unit coventionally includes a light source and a light guide plate. Light generated from the light source is guided by the light guide plate and then provided to the display panel.

### SUMMARY

The disclosure provides a slim type display device including a display panel, an element of which functions as a light guide plate.

An embodiment of the invention provides a display device including: a display member which displays an image; and a light source which provides light to the display member.

In such an embodiment, the display member includes: a base substrate including a front surface, a rear surface, and a plurality of side surfaces which connect the front surface to the rear surface, where the base substrate receives the light from the light source through at least one side surface of the side surfaces and has a first refractive index; a low refractive layer disposed on the front surface of the first base substrate and having a second refractive index less than the first refractive index; and an array layer disposed on the low refractive layer and including at least one thin film transistor,

In such an embodiment, the light received by the first base substrate is incident to the low refractive layer, and, the low refractive layer has a predetermined thickness, which is greater than a penetration depth of the light in the low refractive layer.

In an embodiment, the light received by the first base substrate may be incident to the low refractive layer at an angle greater than a critical angle for the total reflection at a boundary between the first base substrate and the low refractive layer.

In an embodiment, the low refractive layer may have a thickness of about 1 micrometer (μm) or greater.

In an embodiment, the first base substrate may include a glass.

In an embodiment, the second refractive index may be in a range of about 1.0 to about 1.4.

In an embodiment, the low refractive layer may be disposed directly on the first base substrate.

In an embodiment, the low refractive layer may include a plurality of nano rods.

In an embodiment, each of the nano rods may include a silicon oxide.

In an embodiment, each of the nano rods may be inclined with respec to the front surface.

In an embodiment, air may be filled in a space defined between the nano rods.

In an embodiment, the display member may further include: a first substrate; a second substrate disposed on the first substrate; a liquid crystal layer disposed between the first substrate and the second substrate; and a seal pattern which couples the first substrate to the second substrate and encapsulates the liquid crystal layer. In such an embodiment, the first substrate may include the first base substrate, the low refractive layer, and the array layer.

In an embodiment, the second substrate may include a second base substrate, and a color filter layer disposed between the second base substrate and the liquid crystal layer.

In an embodiment, the display member may further include: a first layer disposed between the array layer and the low refractive layer; a second layer disposed between the first layer and the array layer; and a polarizing layer disposed between the first layer and the second layer, where the polarizing layer may include a plurality of metal nano rods.

In an embodiment, the display member may further include a first pattern layer disposed between the first base substrate and the low refractive layer, in which a plurality of lenticular lens patterns is defined in the first pattern layer.

In an embodiment, the first pattern layer may have substantially the same refractive index as the first refractive index.

In an embodiment, the display device may further include a second pattern layer disposed on the rear surface of the first base substrate, where a plurality of engraved patterns is defined in the second patter layer, and the second pattern layer may have substantially the same refractive index as the first refractive index.

In an embodiment, a cross-sectional shape of each of the engraved patterns may include a pyramid shape.

In an embodiment, air may be filled into a space defined by the engraved patterns.

In an embodiment of the invention, a display device includes: a display member which displays an image; and a light source which provides light to the display member, where the display member includes: a base substrate including a front surface, a rear surface, and a plurality of side surfaces which connects the front surface to the rear surface, where the base substrate receives the light through a side surface of the side surfaces and has a first refractive index; a low refractive layer disposed on the front surface, where the low refractive layer has a second refractive index less than the first refractive index and a thickness of about 1 μm or greater; and an array layer disposed on the low refractive layer and including a thin film transistor.

In an embodiment, the low refractive layer may include a plurality of nano rods spaced apart from each other, and an air layer filled into spaces defined between the nano rods.

### BRIEF DESCRIPTION OF THE FIGURES

The accompanying drawings are included to provide a further understanding of the invention, and are incorporated in and constitute a part of this specification. The drawings illustrate exemplary embodiments of the invention and, together with the description, serve to explain principles of the invention. In the drawings:

FIG. 1 is an exploded perspective view of a display device according to an embodiment of the invention;

FIG. 2 is a schematic cross-sectional view of the display device according to an embodiment of the invention;

FIG. 3 is an enlarged cross-sectional view illustrating a portion of the display device of FIG. 2;

FIG. 4A is a partial cross-sectional view of a first substrate according to a comparative embodiment;

FIG. 4B is a partial cross-sectional view of a first substrate according to an embodiment of the invention;

FIG. 4C is a partial cross-sectional view of the first substrate according to another comparative embodiment;

FIG. 4D is a profile illustrating light guidance in a plurality of medium layers as light intensities;

FIGS. 5A to 5C are cross-sectional views illustrating examples of a low refractive layer according to an embodiment of the invention;

FIG. 6 is a partial cross-sectional view showing various embodiments of the low refractive layer;

FIG. 7 is a cross-sectional view of a display device according to an embodiment of the invention; and

FIG. 8 is a cross-sectional view of a first substrate according to an embodiment of the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described with reference to the accompanying drawings.

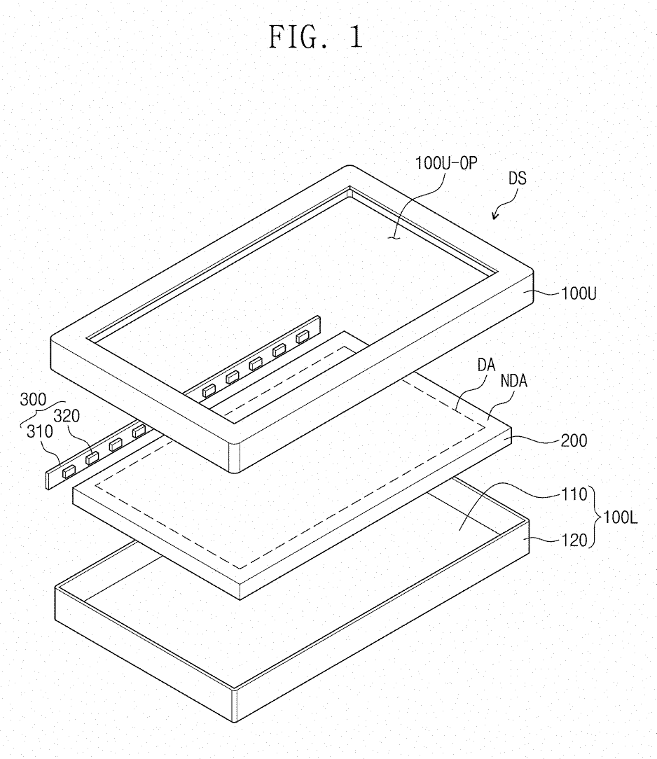

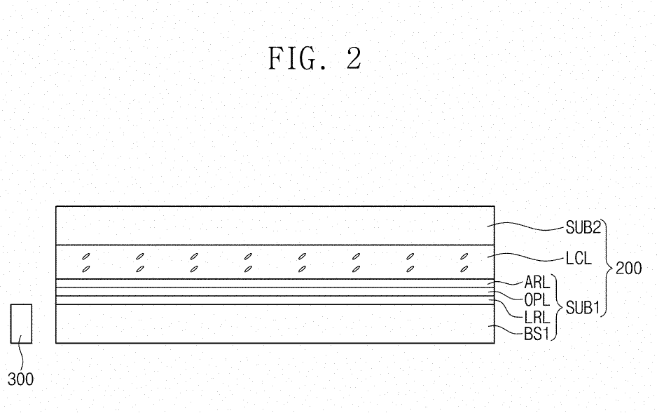

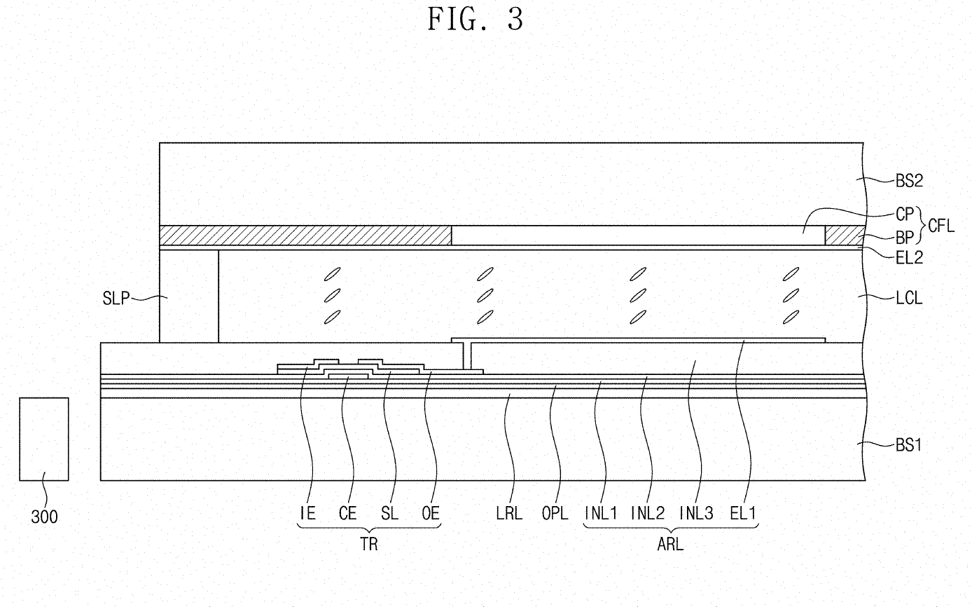

FIG. 1 is an exploded perspective view of a display device according to an embodiment of the invention. FIG. 2 is a schematic cross-sectional view of the display device according to an embodiment of the invention. FIG. 3 is an enlarged cross-sectional view illustrating a portion of the display device of FIG. 2.

For convenience of description, a portion of components of FIG. 1 may be omitted in FIG. 2. Hereinafter, a display device DS according to an embodiment of the invention will be described in detail with reference to FIGS. 1 to 3.

As illustrated in FIG. 1, an embodiment of the display device DS includes an upper protection member 100U, a lower protection member 100L, a display member 200, and a light source 300. The upper protection member 100U and the lower protection member 100L may be coupled to each other to define an outer appearance of the display device DS.

An opening 100U-OP is defined in the upper protection member 100U. A user may see an image through the opening 100U-OP. Although not shown, a transparent member formed of a material having high transparency or transmittance may be further disposed in the opening 100U-OP.

The lower protection member 100L may include a bottom part 110 and a side part 120. The bottom part 110 may have a shape corresponding to that of the display member 200. In an embodiment, as shown in FIG. 1, the bottom part 110 has a rectangular shape.

The side part 120 is bent upward from the bottom part 110. The side part 120 surrounds the bottom part 110. The bottom part 110 and the side part 120 define a predetermined inner space. The display member 200 and the light source 300 are accommodated into the inner space.

The display member 200 displays an image based on an electrical signal. The display member 200 is divided into a display area DA and a non-display area NDA on a plane or when viewed from a top plan view.

The display area may be mainly defined at a center of the display member 200. A plurality of pixels (not shown) is disposed in the display area DA. Each of the pixels may generate an image corresponding to an electrical signal applied thereto. The opening 100U-OP of the upper protection member 100U exposes at least the display area DA.

The non-display area NDA surrounds the display area DA. In an embodiment, as shown in FIG. 1, the non-display area NDA may have a frame shape. Various driving circuits may be disposed in the non-display area NDA.

Even though the electrical signal may be applied to the non-display area NDA, an image is not displayed on the non-display area NDA. The non-display area NDA may be covered by the upper protection member 100U.

In an embodiment, display members 200 may be one of various types of display panel that displays an image based on an electrical signal. In one embodiment, for example, the display member 200 may be a liquid crystal display panel. Hereinafter, for convenience of description, embodiments where the display member 200 is a liquid crystal display panel will be described in detail, but not being limited thereto.

In an embodiment, the light source 300 includes a circuit board 310 and a plurality of light emitting units 320. The circuit board 310 may have various shapes. In an embodiment, as shown in FIG. 1, the circuit board 310 may have a bar shape that extends along one side of the display member 200.

The light emitting units 320 are disposed or mounted on the circuit board 310. The light emitting units 320 are arranged along one side of the display member 200. The light emitting units 320 provide light to the one side of the display member 200.

The light emitting units 320 receive a driving voltage from the circuit board 310 to generate light. Each of the light emitting units 320 may include at least one of various light emitting elements. In one embodiment, for example, each of the light emitting units 320 may include a light emitting diode (“LED”) or a laser diode (“LD”).

An embodiment of the display member 200 will hereinafter be descried in greater detail with reference to FIGS. 2 and 3. The display member 200 may include a first substrate SUB1, a liquid crystal layer LCL, and a second substrate SUB2. The liquid crystal layer LCL is disposed between the first substrate SUB1 and the second substrate SUB 2.

The first substrate SUB1 may include a first base substrate BS1, a low refractive layer LRL, an optical layer OPL, and an array layer ARL. The first base substrate BS1 may include or be formed of an insulation material having high transmittance.

The first base substrate BS1 may have a plate-like shape having a front surface, a rear surface, and a plurality of side surfaces. The first base substrate BS1 has a first refractive index. In one embodiment, for example, the first base substrate BS1 may be a glass substrate.

In such an embodiment, as described above, the light source 300 provides light at least one side surface of the side surfaces of the first base substrate BS1. Thus, the at least one of the side surfaces of the first base substrate BS1 may be defined as a light incident surface.

In such an embodiment, the front surface of the first base substrate BS1 may be defined as a light emission surface. Light incident into the side surface of the first base substrate BS1 may be emitted through the entire front surface of the first base substrate BS1 while or after proceeding through the inside of the first base substrate BS1.

The low refractive layer LRL is disposed on the front surface of the first base substrate BS1. The low refractive layer LRL has a second refractive index less than the first refractive index. The low refractive layer LRL improves a light guide function of the first base substrate BS1.

In an embodiment, the low refractive layer LRL may be disposed directly on or contact the first base substrate BS1. In such an embodiment, the first base substrate BS1 may function as a core, and the low refractive layer LRL may function as a cladding.

Thus, light, which is incident into the low refractive layer LRL at a critical angle or greater, of light incident through the one side surface of the first base substrate BS1 may be totally reflected to the inside of the first base substrate BS1 at a boundary between the first based substrate BS and the low refractive layer LRL. As a result, the first base substrate BS1 may substantially function as the light guide plate. This will be described later in detail.

The optical layer OPL is disposed between the low refractive layer LRL and the array layer ARL. The optical layer OPL may have various functions. In one embodiment, for example, the optical layer OPL may polarize or diffuse the incident light. Alternatively, the optical layer OPL may collect the incident light to improve light efficiency in a specific region. However, the above-described features are merely exemplary. In one embodiment, for example, the optical layer OPL of the first substrate SUB1 may be omitted.

An array layer ARL is disposed between the low refractive layer LRL and the liquid crystal layer LCL. The array layer ARL includes a plurality of thin film layers. The thin film layers may include a thin film transistor TR and a plurality of insulation layers, e.g., a first insulation layer INL1, a second insulation layer INL2 and a third insulation layer INL3.

The first insulation layer INL1 may be disposed between the thin film transistor TR and the optical layer OPL. The first insulation layer INL1 may be a protection layer for preventing the optical layer from being damaged during a process of forming the thin film transistor TR thereon.

Alternatively, the first insulation layer INL1 may be a planarization layer providing a planar or flat surface on the thin film transistor TR. However, the above-described features are merely exemplary. In one alternative embodiment, for example, the first insulation layer INL1 of the first substrate SUB1 may be omitted.

A control electrode CE of the thin film transistor TR is disposed on the low refractive layer LRL. The thin film transistor TR may be turned on or off in response to a gate signal transmitted to the control electrode CE.

A semiconductor layer SL, in which a channel of the thin film transistor TR is formed, may be disposed on the control electrode CE. The second insulation layer INL2 may be disposed between the control electrode CE and the semiconductor layer SL. The second insulation layer INL2 insulates the control electrode CE from other components.

An input electrode IE and an output electrode OE of the thin film transistor TR are disposed on the semiconductor layer SL. The input electrode IE and the output electrode OE are disposed to be spaced apart from each other. The input electrode IE and the output electrode OE may partially overlap the control electrode CE when viewed from a top view or a plan view in a thickness direction of the display member 200.

The third insulation layer INL3 is disposed on the thin film transistor TR. The third insulation layer INL3 insulates the thin film transistor TR from other components and provides a plane or flat surface on an upper portion thereof. Although not shown, each of the first to third insulation layers INL1, INL2, and INL3 may include organic layers and/or inorganic layers. However, the embodiment of the invention is not limited thereto.

The first substrate SUB1 may further include a first electrode EL1. The first electrode EL1 is disposed on the third insulation layer INL3. The first electrode EL1 may extend through the third insulation layer INL3 and is connected to the thin film transistor TR. In one embodiment, a contact hole may be defined through the third insulation layer INL3 to allow the first electrode EL1 to be electrically connected to the output electrode of the thin film transistor TR.

The display member 200 may include a second substrate SUB2. In an embodiment, as shown in FIG. 3, the second substrate SUB2 may be a color filter substrate. In such an embodiment, the second substrate SUB2 includes a second base substrate BS2, a color filter layer CFL, and a second electrode EL2.

The second base substrate BS2 may be disposed on the first substrate SUB1. The second base substrate BS2 may be a glass substrate.

The color filter layer CFL may be disposed on one surface, e.g., a bottom surface, of the second base substrate BS2. The color filter layer CFL includes a color pattern CP and a black matrix BP. The color pattern CP has a predetermined color. Light incident into and passed through the color pattern CP is may have a color of the color pattern CP.

The black matrix BP is adjacent to the color pattern CP. The black matrix BP effectively blocks the incident light.

The second electrode EL2 is disposed on the color filter layer CFL. The second electrode EL2 faces the first electrode EL1. However, the above-described features are merely exemplary. In one alternative embodiment, for example, the second electrode EL2 may be disposed on the first substrate SUB1.

In an embodiment, light transmittance of the liquid crystal layer LCL may be controlled by an electric field generated between the first electrode EL1 and the second electrode EL2. An image to be displayed on the display member 200 may be embodied based on the light transmittance of the liquid crystal layer LCL controlled by the electric field.

The display member 200 may further include a seal pattern SLP. The seal pattern SLP is disposed in an edge portion of the display member 200 to couple the first substrate SUB1 to the second substrate SUB2. The liquid crystal layer LCL may be encapsulated by the seal pattern SLP and thus not be exposed to the outside. Thus, the liquid crystal layer LCL may be stably disposed between the first and second substrates SUB1 and SUB2.

In an embodiment of the invention, as described above, the first substrate SUB1 may include the array layer and also function as the light guide plate for guiding light. Thus, according to an embodiment of the invention, a light guide plate, which is conventionally provided in a display device including a backlight, may be omitted such that a thickness of the display device DS may be reduced.

In such an embodiment of the invention, the low refractive layer LRL may be further provided to improve light guide efficiency of the first base substrate BS1. Thus, the first base substrate BS1 may effectively function as a substantial light guide plate without being affected by the array layer ARL or the optical layer OPL, which is disposed above the first base substrate BS1.

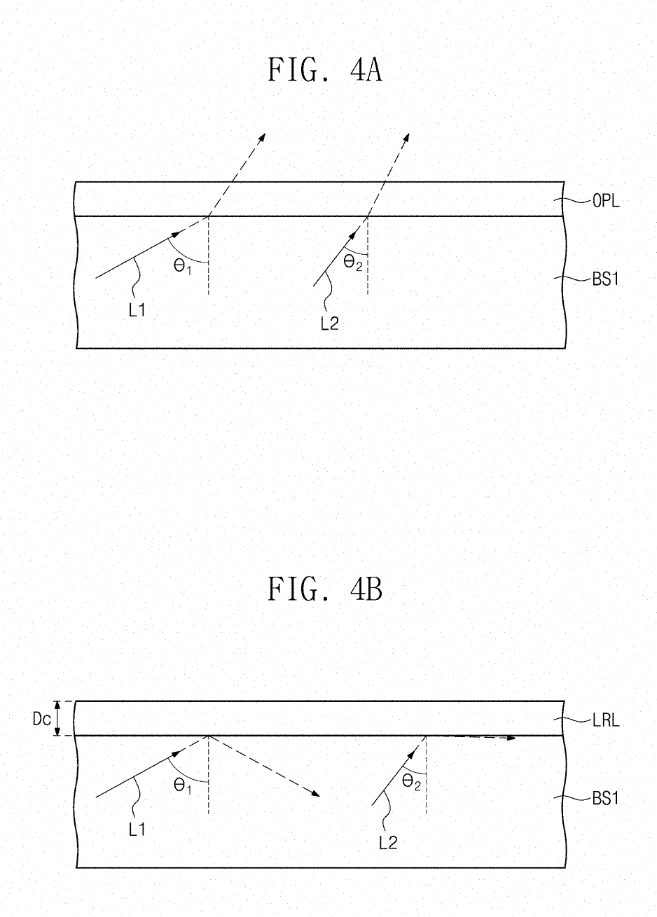

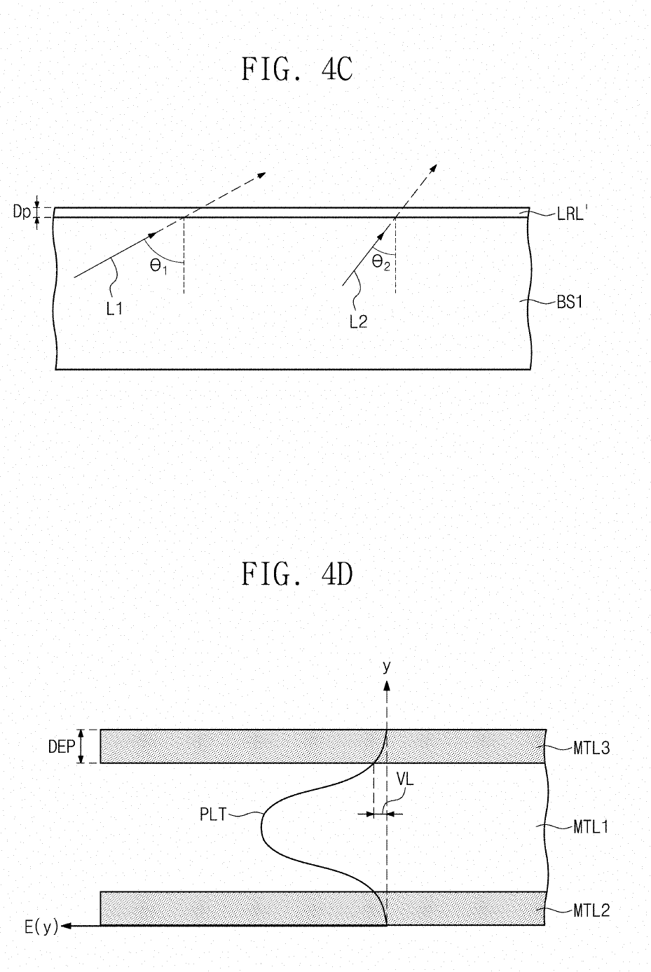

FIG. 4A is a partial cross-sectional view of a first substrate according to a comparative embodiment. FIG. 4B is a partial cross-sectional view of a first substrate according to an embodiment of the invention. FIG. 4C is a partial cross-sectional view of the first substrate according to another comparative embodiment. FIG. 4D is a profile illustrating light guidance in a plurality of medium layers as light intensities.

For convenience of description, only the first base substrate BS1 and a layer contacting the first base substrate BS1 are illustrated in FIGS. 4A to 4D. Hereinafter, a relationship between the low refractive layer and the first base substrate will be described with reference to FIGS. 4A to 4D.

FIG. 4A illustrates a structure of a comparative embodiment in which the optical layer OPL is disposed on the first base substrate BS1, and FIG. 4B illustrates a structure of an embodiment of the invention in which the low refractive layer LRL is disposed on the first base substrate BS1. That is, in the comparative embodiment illustrated in FIG. 4A, the low refractive layer LRL is not provided. Hereinafter, an effect of the low refractive layer LRL, which affects the light guide efficiency, will be described with reference to FIGS. 4A to 4D.

In general, the proceeding of the light between two media having refractive indexes different from each other may be determined by a refractive index and an incident angle.

$$\frac{{n}_{LY 1}}{{n}_{LY 2}} = \frac{sin {θ}_{LY 2}}{sin {θ}_{LY 1}} \qquad [ Equation 1 ]$$

Referring to Equation 1, a refractive index n_{LY1} of the lower layer may be a refractive index of the first base substrate BS1, and refractive index n_{LY2} of the upper layer may be a refractive index of the optical layer OPL contacting the first base substrate BS1.

When the optical layer OPL has a refractive index greater than that of the first base substrate BS1, a ratio (n_{LY1}/n_{LY2}) between the refractive indexes n_{LY1} and n_{LY2} may have a value less than 1. Since a value of sin θ increases in angle θ within a range of 90 degrees, when the incident angle is greater than the emission angle, the refractive index ratio (n_{LY1}/n_{LY2}) less than 1 may be satisfied.

That is, most of the first light L1 and the second light L2, which are incident from the first base substrate BS1 to the optical layer OPL, may proceed in a direction in which the light passes through the optical layer OPL, regardless of incident angles of the first and second light L1 and L2.

Thus, as illustrated in FIG. 4A, all the first light L1 incident into the optical layer OPL at a first angle θ1 and the second light L2 incident into the optical layer OPL at a second angle θ2 that is less than the first angle θ1 may pass though the optical layer OPL and be emitted to an upper side of the optical layer OPL.

In an embodiment of the invention, as described herien, the low refractive layer LRL may have a second refractive index that is less than the first refractive index of the first base substrate BS1. When the refractive index of the low refractive layer LRL contacting the first base substrate BS1 is substituted for the refractive index n_{LY2} of the upper layer, the refractive index ratio (n_{LY1}/n_{LY2}) may be greater than 1.

Thus, when the emission angle is greater than the incident angle, the refractive index ratio (n_{LY1}/n_{LY2}) that is greater than 1 may be satisfied. As a result, light incident at an angle that is greater than the incident angle, i.e., about 90 degrees that is a maximum emission angle may be totally reflected from the low refractive layer LRL.

Here, when the light is totally reflected Equation 1 may not be applied. However, a critical angle θ_{c}, at an angle above which the total reflection occurs, may be derived from Equation 1 by substituting the refractive index of the first base substrate BS1 and the refractive index of the low refractive layer LRL, as shown in the following Equation 2.

$$\frac{{n}_{LY 1}}{{n}_{LY 2}} = \frac{sin {θ}_{LY 2}}{sin {θ}_{LY 1}} = \frac{sin 90 °}{sin {θ}_{LY 1}} = \frac{1}{{θ}_{c}} \qquad [ Equation 2 ]$$

For convenience of description, a case in which the second angle θ₂ is the critical angle θ_{c} will be illustrated in FIG. 4B as an example. When the incident angle is the critical angle, the emission angle may be about 90 degrees. Thus, the second light L2 may proceed along an interface between the low refractive layer LRL and the first base substrate BS1.

Referring to Equation 2, theoretically, the critical angle θ_{c} for the total reflection at a boundary between two medium layers may be determined by refractive indexes of the two medium layers. The display device according to an embodiment of the invention may be designed in a way such that the light proceeding at an angle of at least 40 degrees or greater is guided.

Light, which is incident at the second angle θ₂ or greater that is the critical angle θ_{c}, of the light incident from the first base substrate BS1 to the low refractive layer LRL may be totally reflected at the boundary between the low refractive layer LRL and the first base substrate BS1, and then guided to the inside of the first base substrate BS1. The first light L1 incident at the first angle θ₁ that is greater than the second angle θ₂ or the critical angle θ_{c} may be totally reflected from the low refractive layer LRL to proceed to the inside of the first base substrate BS1.

In an embodiment, the low refractive layer LRL may have a predetermined thickness. A low refractive layer LRL having a first thickness Dc is illustrated in FIG. 4B, and a low refractive layer LRL′ having a second thickness Dp is illustrated in FIG. 4C. The low refractive layer LRL of FIG. 4B and the low refractive layer LRL′ of FIG. 4C may be formed of the same material. Also, the first base substrate BS1 may be maintained under the same condition. Hereinafter, a difference in light guide efficiency depending on a thickness of the low refractive layer will be described with reference to FIGS. 4B and 4C.

Referring to FIGS. 4B and 4C, when the low refractive layer LRL varies in thickness under the same refractive index, the proceeding pattern of the second light L2 in the low refractive layer LRL may be changed. The second light L2 incident into the low refractive layer LRL′ having the second thickness Dp that is relatively small may pass through the low refractive layer LRL′ even though the second light L2 is incident at the second angle θ₂ that is defined as the critical angle θ_{c}.

This will be described in greater detail with reference to FIG. 4D. A plurality of medium layers, and an electric field intensity E(y) corresponding to a light intensity according to a variation y on a cross-section are illustrated in FIG. 4D.

A profile PLT of light is illustrated based on light proceeding through the inside of a first medium layer MTL1. Here, a variation in intensity of light when the light is incident from the first medium layer MTL1 to second and third medium layers MTL2 and MTL3 is shown.

The medium layers include the first medium layer MTL1, the second medium layer MTL2, and the third medium layer MTL3. The first medium layer MTL1 is disposed between the second medium layer MTL2 and the third medium layer MTL3. The first medium layer MTL1 has a refractive index greater than that of the second medium layer MTL2 and greater than that of the third medium layer MTL3.

As illustrated in FIG. 4D, the electric field intensity E(y) is exponential-functionally reduced as light processes from a boundary between the first and third medium layers MTL1 and MTL3 to the inside of the third medium layer MTL3.

When the electric field intensity VL at the boundary between the two medium layers having refractive indexes different from each other is 1/e, a thickness of the third medium layer MTL 3 defining the boundary together with the first medium layer MTL1 may be a maximum depth by which the light is penetrated into the third medium layer MTL3, i.e., a penetration depth. The penetration depth may be substantially the same as a minimum thickness at which a frustrated total internal reflectance does not occur.

When the thickness of the third medium layer MTL3 defining the boundary together with the first medium layer MTL1 is greater than the penetration depth, light incident from the first medium layer MTL1 to the third medium layer MTL3 does not penetrate the third medium layer MTL3 and thus does not pass through the third medium layer MTL3. Thus, the light incident from the first medium layer MTL1 to the third medium layer MTL3 may be effectively totally reflected at the boundary between the first medium layer MTL1 and the third medium layer MTL3.

However, when the thickness of the third medium layer MTL3 defining the boundary together with the first medium layer MTL1 is less than the penetration depth, light incident from the first medium layer MTL1 to the third medium layer MTL3 does not recognize the third medium layer MTL3 as the boundary and thus passes through the third medium layer MTL3 and be emitted to the outside.

As a result, the thickness DEP of the third medium layer MTL 3, at which the electric field intensity VL at the boundary between the first medium layer MTL1 and the third medium layer MTL3 satisfies 1/e, may be a penetration depth of the light incident from first medium layer MTL1 to the third medium layer MTL3.

For convenience of description, although the first and third medium layers MTL1 and MTL3 are mainly described, the above-described features may be equally applied to the first and second medium layers MTL1 and MTL2.

The first medium layer MTL1 may function as a core, and each of the second and third medium layers MTL2 and MTL3 may function as a cladding. When each of the second and third medium layers MTL2 and MTL3 has a thickness greater than the penetration thickness, the light proceeding through the inside of the first medium layer MTL1 may be reflected by the second and third medium layers MTL2 and MTL3 to travel back to the inside of the first medium layer MTL1. Thus, the first medium layer MTL1 may function as the core to continuously guide the light proceeding at a predetermined angle or greater into the first medium layer MTL1.

The penetration depth may be numerically derived with reference to the following Equation 3.

$$K = \frac{ω}{c} \sqrt{{n}_{1}^{2} {sin}^{2} {θ}_{c} + {n}_{2}^{2} } \qquad [ Equation 3 ]$$

A reciprocal number (1/K) of K of Equation 3 may be a substantial penetration depth of light incident from the first medium layer MTL1 to the third medium layer MTL3 in the third medium layer MTL3. The penetration depth (1/K) may be derived by an expression using a ratio of an angular speed ω of light incident into the third medium layer MTL3 to a light speed c, a refractive index n₁ of the first medium layer MTL1, a refractive index n₃ of the third medium layer MTL3, and a critical angle θ_{c} of the light incident from the first medium layer MTL1 to the third medium layer MTL3.

Referring again to FIGS. 4B and 4C, a thickness Dc of the low refractive layer LRL of FIG. 4B may be greater than the penetration depth of the second light L2 in the low refractive layer LRL. In one embodiment, for example, where the first base substrate BS1 is a glass substrate, and the low refractive layer LRL has a refractive index of about 1.2 or less, the second light L2 incident at the critical angle may have a penetration depth of about 1 micrometer (μm). Since the low refractive layer LRL may have a thickness of about 1 μm or grater, the light incident at the critical angle or greater may be easily guided into the first base substrate BS1.

If the thickness Dp of the low refractive layer LRL′ of FIG. 4C is less than the penetration depth of the second light L2 in the low refractive layer LRL′, the second light L2 does not experience the low refractive layer LRL′ as the cladding, but passes through the low refractive layer LRL′ as it is, although the low refractive layer LRL′ having the same refractive index as the low refractive layer LRL of FIG. 4B defines the boundary together with the first base substrate BS1.

In an embodiment of the invention, the low refractive layer LRL may have a refractive index relatively lower than that of the first base substrate BS1 and have a thickness greater than the penetration depth of the light incident from the first base substrate BS1 to the low refractive layer LRL in the low refractive layer LRL. Thus, even though the glass substrate is used as the first base substrate BS1, the first base substrate BS1 may effectively function as the light guide plate to easily realize the thin film display device without using a conventional light guide plate separately provided therein.

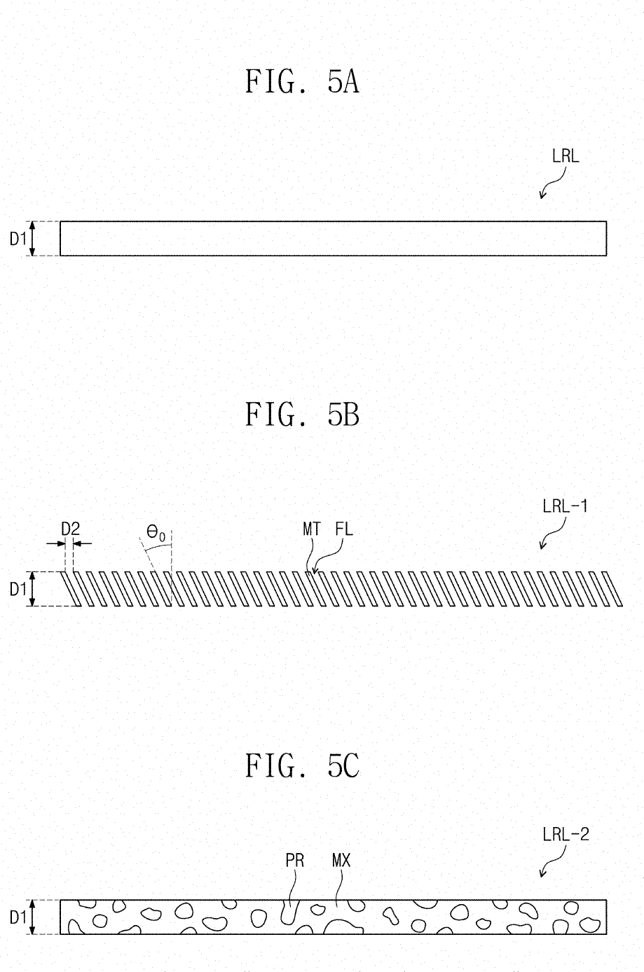

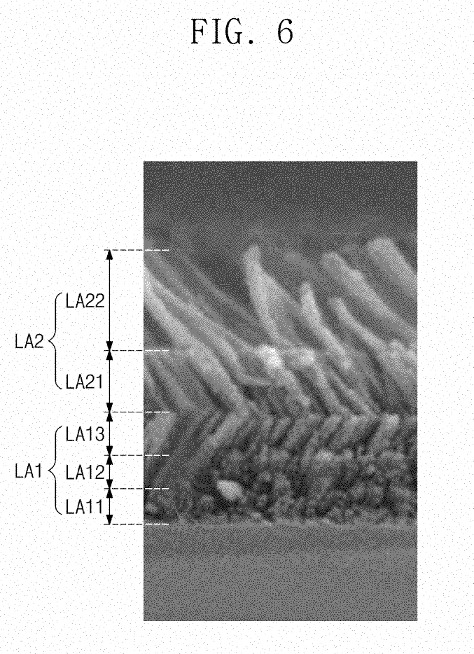

FIGS. 5A to 5C are cross-sectional views illustrating a low refractive layer according to an embodiment of the invention. FIG. 6 is a partial cross-sectional view showing various embodiments of the low refractive layer.

Referring to FIG. 5A, an embodiment of the low refractive layer LRL has a predetermined thickness D1. In such an embodiment, as described above, the thickness and the refractive index of the low refractive layer LRL may improve the light guide efficiency of the first base substrate BS1.

The thickness D1 of the low refractive layer LRL may be greater than a penetration depth of light, which is incident from the lower layer contacting the low refractive layer LRL, e.g., the first base substrate (not shown) to the low refractive layer LRL, in the low refractive layer LRL.

In an embodiment, where the first base substrate BS1 is a glass substrate, the low refractive layer LRL has a refractive index of about 1.2 or less, and light proceeding through the first base substrate BS1 has a wavelength of a visible light band, the low refractive layer LRL may have a thickness of about 1 μm or greater.

In an embodiment, as illustrated in FIG. 5A, the low refractive layer LRL may have a single layer structure. In one embodiment, for example, the low refractive layer LRL may include or be formed of a porous silicon oxide. The low refractive layer LRL may entirely cover a surface of the first base substrate.

In an alternative embodiment, the low refractive layer LRL may have a structure to to control a refractive index of the low refractive layer LRL. In one embodiment, for example, as illustrated in FIG. 5B, a low refractive layer LRL-1 may include a plurality of nano rods MT.

The nano rods MT may include at least one of various materials. The nano rods MT may include a material having a refractive index less than that of a first base substrate BS1 and a material having a refractive index greater than that of the first base substrate BS1.

In one embodiment, for example, the nano rods MT may include at least one of various materials including a silicon compound such as silicon oxide (SiOx) and silicon nitride (SiNₓ), a metal compound such as magnesium fluoride (MgₓF_{y}), gallium nitride (GaN) and indium tin oxide (“ITO)”, a polymer material such as carbon nanotube and poly(methyl methacrylate) (“PMMA”), and a mixture/compound thereof.

In such an embodiment, where the low refractive layer LRL-1 includes the nano rods MT, the low refractive layer LRL-1 may have a refractive index less than that of a material of the nano rods MT. Thus, in an embodiment where the nano rods MT include a material having a refractive index substantially greater than of the first base substrate BS1, the low refractive layer LRL-1 may have a refractive index less than that of the first base substrate BS1. In such an embodiment, the nano rods MT may be formed through oblique angle deposition. Thus, each of the nano rods MT may be dipsosed in the low refractive layer LRL-1 to be included at a predetermined angle θ₀. In an embodiment of the invention, the nano rods MT of the low refractive layer LRL-1 are formed through the oblique angle deposition, such that the thickness and uniformity of the low refractive layer LRL-1 may be easily controlled.

The nano rods MT may be arranged to be spaced apart from each other with a predetermined pitch or distance D2. Here, a predetermined filler FL may be filled into a spaced space between the nano rods MT. In one embodiment, for example, the filler FL may be air.

In an embodiment of the invention, the shape of the nano rods MT may determined the refractive index of the low refractive layer LRL-1. When the low refractive layer LRL of FIG. 5A and the low refractive layer LRL-1 of FIG. 5B include the same material as each other, the low refractive layer LRL-1 of FIG. 5B has a refractive index different from that of the low refractive layer LRL of FIG. 5A by controlling the structure of the nano rods MT.

The structure of the nano rods MT may include a distance between adjacent nano rods MT of the nano rods MT, a density of the nano rods MT, an arrangement or shape of the nano rods MT such as an inclined angle of each of the nano rods MT, or a shape of each of the nano rods MT. The destruction of a filler FL filled between the nano rods MT may be variously determined based on the structure of the nano rods MT, and an effect of the filler FL on the refractive index of the low refractive layer LRL-1 may vary in degree.

FIG. 6 shows exemplary embodiments of the low refractive layer. FIG. 6 shows a first type layer LA1 including a plurality of layers and a second type layer LA2 including a plurality of layers. Each layer of the first and second type layers LA1 and LA2 may define an embodiment of a low refractive layer or be used as a lower refractive layer. Here, each of the layers of the first type layer LA1 are formed of a same material as each other may have refractive indexes different from each other according to a density thereof, and each of the layers of the second type layer LA2 are formed of a same material as each other may have refractive indexes different from each other according to a density thereof. The layers of the first type layer LA1 are formed of a different material from a material of the layers of the second type layer LA2. In such a structure, the first type layer LA1 may include a first sub layer LA11 having the relatively highest density, a second sub layer LA12 having a middle density, and a third sub layer LA13 having the relatively lowest density within the first layer LA1.

As described above, the first sub layer LA11, the second sub layer LA12 and the third sub layer LA13 may include substantially the same material as each other, but have refractive indexes different from each other. Among the total volumes of pores, in which air exists, of each of the first sub layer LA11, the second sub layer LA12 and the third sub layer LA13, the total volume of the pores in the third sub layer LA13 is the largest. Thus, although the first sub layer LA11, the second sub layer LA12 and the third sub layer LA13 are formed of the same material as each other, the third sub layer LA13 may have a refractive index relatively less than that of the first sub layer LA11.

The second type layer LA2 is made of a material different from that of the first layer LA1 will be described. The second type layer LA2 includes a first sub layer LA21 and a second sub layer LA22. Here, the second sub layer LA22 may have a thickness relatively greater than that of the first sub layer LA21. When each of the first and second sub layers LA21 and LA22 is formed by nano rods, a layer having a relatively larger thickness may be easy to be formed to have a high pore density. Thus, rods the density of the nano rods in the second sub layer LA22 be relatively low. As a result, the second sub layer LA22 may have a relatively high pore density and a relatively low refractive index when compared to that of the first sub layer LA21.

Referring again to FIGS. 5B and 6, in an embodiment of as the pore density increases, an effect of air filled into the pores on the reflective index of the corresponding layer may increase. Air may have a reflective index of about 1.0, which is less than that of each of silicon compounds of the nano rods MT. Thus, the second layer having the relatively high pore density may have a refractive index less than that of the first layer having the relatively low pore density.

Even when the pore density is not changed, the refractive index of the low refractive layer LRL-1 may vary according to the distribution of the pores or the arranged shape of the nano rods MT. In an embodiment, the low refractive layer LRL-1 may have refractive indexes that are partially different from each other or have entirely the same refractive index according to the distribution of the pores or the arranged shape of the nano rods MT therein. The low refractive layer LRL-1 includes the plurality of nano rods MT and the pores corresponding to the nano rods MT. Accordingly, various embodiments of the low refractive layer LRL-1 having a refractive index less than that of the low refractive layer LRL may be embodied, but the embodiment of the invention is not limited thereto.

In another alternative embodiment, as illustrated in FIG. 5C, a low refractive layer LRL-2 may have a porous structure. The low refractive layer LRL-2 may include a matrix MX and a plurality of pores PR defined in the matrix MX.

A material having a refractive index less than that of the matrix MX, e.g., an air, may be filled into the pores PR. The nano rods MT of FIG. 5B may correspond to the porous matrix MX having the plurality of pores.

A refractive index of each of materials of the low refractive layer and refractive indexes of the low refractive layer are shown in Table 1 below.

TABLE 1

| | | Refractive | Refractive |
|---|---|---|---|
| | | index of | index of low |
| | Structure | material | refractive layer |
| Gallium nitride (GaN) | Nano load | 2.30 | 1.50 |
| Indium tin oxide (ITO) | Nano load | 2.19 | 1.29 |
| Silicon oxide (SiO₂) | Nano load | 1.48 | 1.05 |
| magnesium fluoride (MgF₂) | Porous | 1.39 | 1.09 |
| Poly(methyl methacrylate) | Porous | 1.20 | 1.05 |
| (PMMA) | | | |

As shown in Table above, the low refractive layer may have a refractive index that is relatively less than that of a material thereof by changing a structure thereof. The refractive indexes of the materials shown in Table 1 above may correspond to the refractive indexes of the low refractive layer LRL of FIG. 5A, and the refractive indexes of the low refractive layer shown in Table 1 above may correspond to the refractive indexes of the low refractive layer LRL-1 of FIG. 5B or the refractive indexes of the low refractive layer LRL-2 of FIG. 5C. The refractive indexes of the low refractive layer having the nano load structure may correspond to the refractive indexes of the low refractive layer LRL-1 of FIG. 5B, and the refractive indexes of the low refractive layer having the porous structure may correspond to the refractive indexes of the low refractive layer LRL-2 of FIG. 5C.

According to an embodiment of the invention, the refractive index of the low refractive layer may be changed by controlling the structure of the low refractive layer having a porous structure or nano load sturcture including the plurality of pores. Therefore, although the low refractive layer is formed of a material having a refractive index greater than that of the first base substrate BS1, the refractive index of the low refractive layer may become less than that of the first base substrate BS1 by controlling the pores in the low refractive layer. According to an embodiment of the invention, the material or the structure of the lower refractive index may be controlled to easily improve the function of light guiding of the first base substrate BS1.

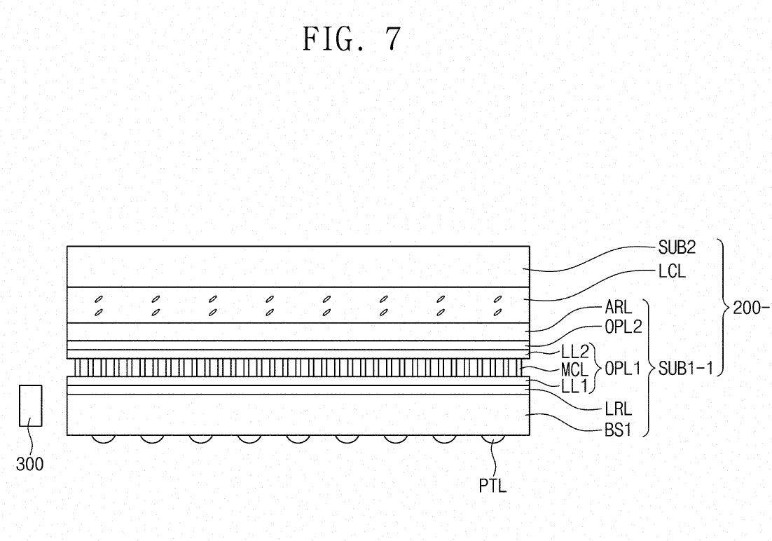

FIG. 7 is a cross-sectional view of the display device according to an embodiment of the invention.

For convenience of illustration and description, FIG. 7 shows a display device corresponding to that of FIG. 2. The same or like elements shown in FIG. 7 have been labeled with the same reference characters as used above to describe the embodiments of the display device shown in FIG. 2, and any repetitive detailed description thereof will hereinafter be omitted or simplified.

Referring to FIG. 7, an embodiment of a display member 200-1 includes a first substrate SUB1-1 including a plurality of optical layers OPL1 and OPL2. The optical layers OPL1 and OPL2 include a first optical layer OPL1 and a second optical layer OPL2.

The first optical layer OPL1 may be a polarizing layer. In one embodiment, for example, the first optical layer OPL1 may be a nano grid polarizer.

In such an embodiment, the first optical layer OPL1 may include a first layer LL1, a second layer LL2, and a micro structural layer MCL. The micro structural layer MCL is disposed between the first layer LL1 and the second layer LL2. The micro structural layer MCL may include a plurality of nano rods including or formed of a metal material.

The first layer LL1 may be disposed on the low refractive layer LRL to provide a plantation surface on the micro structural layer MCL. Thus, the micro structural layer MCL may be stably disposed on the low refractive layer LRL.

The second layer LL2 is disposed on the micro structural layer MCL to provide a planar top surface of the first optical layer OPL1. Thus, the layer to be disposed on the first optical layer OPL1 may be stably disposed on the first optical layer OPL1 without being affected by the micro structural layer MCL.

In such an embodiment, the first layer LL1 and the second layer LL2 support the micro structural layer MCL. The arrangement or structure of the nano rods of the micro structural layer MCL may be stably maintained by the first and second layers LL1 and LL2.

The second optical layer OPL2 is disposed between the first optical layer OPL1 and an array layer ARL. In such an embodiment, the second optical layer OPL2 may be a diffusion layer. In one embodiment, For example, the second optical layer OPL2 may be an insulation layer including a plurality of beads, i.e., an insulation layer including a plurality of diffusion patterns.

A predetermined convex pattern PTL may be further disposed on a rear surface of the first base substrate BS1. The convex pattern layer PTL may effectively prevent light from leaking to the rear surface of the first base substrate BS1 to improve light guide efficiency on the rear surface of the first base substrate BS1.

In an embodiment of the display device according to the invention, the polarizing layer and the diffusion layer may be disposed or inserted into the array substrate, and thus a conventional optical film, which is typically separately provided outside the array substrate, may be omitted. Thus, the ultra slim type display device may be easily realized.

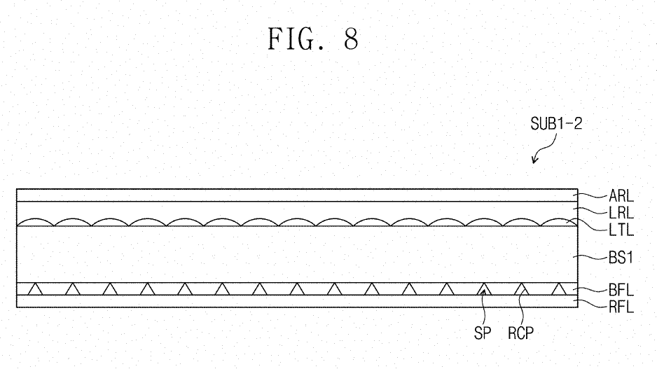

FIG. 8 is a cross-sectional view of a first substrate according to an embodiment of the invention.

In an embodiment, as illustrated in FIG. 8, a first substrate SUB1-2 may further include a lenticular layer LTL, a buffer layer BFL, and a reflection layer RFL.

The lenticular layer LTL may be disposed between the first base substrate BS1 and the low refractive layer LRL. The lenticular layer LTL may have substantially the same refractive index as the first base substrate BS1.

The lenticular layer LTL may include a plurality of lenticular lens patterns. A ratio of a height of each of the lenticular lens patterns to a width of each of the lenticular lens patterns may be about 0.1. In one embodiment, for example, each of the lenticular lens patterns may have a width of about 0.05 millimeter (mm) and a height of about 0.005 mm.

In such an embodiment, the low refractive layer LRL may contact the lenticular layer LTL. Thus, light proceeding through the inside of the first base substrate BS1 may be incident into the low refractive layer LRL via the lenticular layer LTL.

The light incident into the low refractive layer LRL may be incident at various angles by the lenticular layer LTL. In such an embodiment, where the display member further includes the lenticular layer LTL, the lenticular layer LTL may effectively prevent display failures such as column color deviation from occurring.

The buffer layer BFL is disposed on a rear surface of the first base substrate BS1. The buffer layer BFL has substantially the same refractive index as the first base substrate BS1.

A plurality of concave patterns RCP is defined in the buffer layer BFL. A predetermined space SP is defined in each of the concave patterns RCP. Air or a material having a refractive index less than that of the first base substrate BS1 may be disposed in or filled into the space SP.

The shapes of the concave patterns RCP may substantially define a shape of the air of the filling member, which is filled into the space SP. Each of the concave patterns RCP may have at least one of various shapes. In one embodiment, for example, each of the concave patterns RCP may have a pyramid shape or triangular pyramid shape.

The space SP defined by each of the concave patterns RCP and the member filled into the space SP may function as a cladding with respect to the first base substrate BS1. Thus, the light proceeding to the rear surface of the first base substrate BS1 may be totally reflected by the space SP defined by each of the concave patterns RCP and the member filled into the space SP.

In such an embodiment, the light reflected from the buffer layer BFL may be reflected at various angles by the space SP defined by each of the concave patterns RCP and the member filled into the space SP. Thus, the buffer layer BFL may function as a scattering reflection film.

The reflection layer RFL may be disposed on the rear surface or an outer surface of the buffer layer BFL. The reflection layer RFL may contact the buffer layer BFL.

In such an embodiment, the reflection layer RFL may cause specular reflection. Thus, light of the light incident into the buffer layer BFL, which is not reflected by the concave patterns RCP, but passes through the buffer layer BFL, may be incident again into the first base substrate BS1 by the reflection layer RFL.

In an embodiment, as described above, the first substrate SUB1-2 according to an embodiment of the invention may include the lenticular layer LTL to improve light uniformity on the entire surface of the first substrate SUB1-2. In such an embodiment, the first substrate SUB1-2 may further include the buffer layer BFL and the reflection layer RFL to improve the light guide efficiency on the rear surface of the first base substrate BS1, thereby improving the light efficiency.

According to embodiments of the invention, the base substrate on which the array layer is disposed may be improved in light guide efficiency to substantially provide the array substrate with which the light guide plate is integrated. Also, according to embodiments of the invention, the optical layers functioning as the optical films may be integrated with the array substrate to provide the slim type display device.

It will be apparent to those skilled in the art that various modifications and variations can be made in the invention. Thus, it is intended that the disclosure covers the modifications and variations of this invention provided they come within the scope of the appended claims and their equivalents.

Hence, the real protective scope of the invention shall be determined by the technical scope of the accompanying claims.

What is claimed is:

1. A display device comprising:
a display member which displays an image; and
a light source which provides a light to the display member,
wherein the display member comprises:
a first base substrate comprising a front surface, a rear surface, and a plurality of side surfaces which connects the front surface to the rear surface, wherein the light source face a side surface of the side surfaces, the first base substrate receives the light from the light source through the side surface of the side surfaces, and the first base substrate has a first refractive index;
a low refractive layer disposed on the front surface of the first base substrate and having a second refractive index less than the first refractive index; and
an array layer disposed on the low refractive layer and comprising at least one thin film transistor,
wherein the low refractive layer has a predetermined thickness, which is greater than a penetration depth of a light incident to the low refractive layer in the low refractive layer.

2. The display device of claim 1, wherein the light received by the first base substrate is incident to the low refractive layer from the first base substrate at an angle greater than a critical angle for the total reflection at an interface between the first base substrate and the low refractive layer.

3. The display device of claim 2, wherein the low refractive layer has a thickness of about 1 μm or greater.

4. The display device of claim 2, wherein the first base substrate comprises a glass.

5. The display device of claim 2, wherein the second refractive index is in a range from about 1.0 to about 1.4.

6. The display device of claim 1, wherein the low refractive layer is disposed directly on the first base substrate.

7. The display device of claim 6, wherein the low refractive layer comprises a plurality of nano rods.

8. The display device of claim 7, wherein each of the nano rods comprises a silicon oxide.

9. The display device of claim 7, wherein each of the nano rods is inclined with respect to the front surface.

10. The display device of claim 7, wherein air is filled in a space defined between the nano rods.

11. The display device of claim 1, wherein the display member further comprises:
a second base substrate disposed opposite to the first base substrate;
a liquid crystal layer disposed between the first base substrate and the second base substrate; and
a seal pattern disposed between the first base substrate and the second base substrate and the seal pattern which encapsulates the liquid crystal layer.

12. The display device of claim 11, wherein the display member further comprises:
a color filter layer disposed between the second base substrate and the liquid crystal layer.

13. The display device of claim 11, wherein the display member further comprises:
a first layer disposed between the array layer and the low refractive layer;
a second layer disposed between the first layer and the array layer; and
a polarizing layer disposed between the first layer and the second layer, wherein the polarizing layer comprises a plurality of metal nano rods.

14. The display device of claim 1, wherein the display member further comprises:
a first pattern layer disposed between the first base substrate and the low refractive layer,
wherein a plurality of lenticular lens patterns is defined in the first pattern layer.

15. The display device of claim 14, wherein the first pattern layer has substantially the same refractive index as the first refractive index.

16. The display device of claim 14, further comprising:
a second pattern layer disposed on the rear surface of the first base substrate,
wherein a plurality of engraved patterns is defined in the second patter layer, and
wherein the second pattern layer has substantially the same refractive index as the first refractive index.

17. The display device of claim 16, wherein a cross-sectional shape of each of the engraved patterns comprises a pyramid shape.

18. The display device of claim 16, wherein air is filled into a space defined by the engraved patterns.

19. A display device comprising:
a display member which displays an image; and
a light source which provides light to the display member,
wherein the display member comprises:
a base substrate comprising a front surface, a rear surface, and a plurality of side surfaces which connects the front surface to the rear surface, wherein the base substrate receives the light through a side surface of the side surfaces, the side surface faces to the light source, and the base substrate has a first refractive index;
a low refractive layer disposed on the front surface, wherein the low refractive layer has a second refractive index less than the first refractive index and a thickness of about 1 μm or greater; and
an array layer disposed on the low refractive layer and comprising a thin film transistor.

20. The display device of claim 19, wherein the low refractive layer comprises:
a plurality of nano rods spaced apart from each other; and
an air layer filled into spaces defined between the nano rods.
